(19) United States
(12) Patent Application Publication
(10) Pub. No.: US 2026/0158663 A1
(43) Pub. Date: Jun. 11, 2026

(54) SYSTEMS AND METHODS FOR OBJECT PROCESSING WITH PROGRAMMABLE MOTION DEVICES USING VACUUM PLUNGE GRIPPERS

(71) Applicant: Berkshire Grey Operating Company, Inc., Bedford, MA (US)

(72) Inventors: Jeffrey Ian LIPTON, Sharon, MA (US); Bretton ANDERSON, Westford, MA (US); William Chu-Hyon MCMAHAN, North Cambridge, MA (US); Peter Gerard KELLY, Boston, MA (US)

(21) Appl. No.: 19/410,498

(22) Filed: Dec. 5, 2025

Related U.S. Application Data
(60) Provisional application No. 63/728,987, filed on Dec. 6, 2024.

(51) Int. Cl. B25J 9/16; B25J 15/06; B25J 9/00

(52) U.S. Cl. CPC B25J 9/1697; B25J 9/1633; B25J 15/0683; B25J 9/0093

(57) ABSTRACT

An end-effector system for programmable motion devices (e.g., robotic systems) with elongated apertures on a front side and a wedge-shaped tip at a distal end provides high flow vacuum at the plurality of apertures to grasp objects in a direction that is generally transverse to the vacuum force. The end-effector is attached to an arm attachment portion that is attached to an articulated arm of the robotic system.

### PRIORITY

The present application claims priority to U.S. Provisional Patent Application 63/728,987 filed December 6, 2024, the disclosure of which is hereby incorporated by reference in its entirety.

### BACKGROUND

The invention generally relates to programmable motion systems and relates in particular to end-effectors for programmable motion devices (e.g., robotic systems) for use in object processing systems such as object sortation systems.

End-effectors for robotic systems may be employed, for example, in certain applications to select and grasp an object, and then move the acquired object very quickly to a new location. End-effectors should be designed to quickly and easily select and grasp an object from a jumble of dissimilar objects, and should be designed to securely grasp an object during movement. Certain end-effectors, when used on different objects of different physical sizes, weights and materials, may have limitations regarding how securely they may grasp an acquired object, and how securely they may maintain the grasp on the object during rapid movement, particularly rapid acceleration and deceleration (both angular and linear). Further, in certain applications it may be desired to place an object at a destination in a required orientation or pose, particularly with respect to an environment such as a container being packed by a robotic system.

Many end-effectors employ vacuum pressure for acquiring and securing objects for transport and/or subsequent operations by articulated arms. Other techniques for acquiring and securing objects involve electrostatic attraction, magnetic attraction, needles for penetrating objects such as fabrics, fingers that squeeze an object, hooks that engage and lift a protruding feature of an object, and collets that expand in an opening of an object, among other techniques.

In applications where vacuum pressure is used to acquire and secure objects, an end-effector on an articulated arm may include a vacuum cup having a compliant portion, e.g., a bellows portion that contacts the object to be grasped. The compliant portion may be formed of a polymeric or elastomeric material that is flexible enough to allow it to change its shape to adapt to variations in object surface structures, and to varying physical relationships between the articulated arm and the object, such as for example varying angles of approaches to objects. The flexibility further allows the vacuum cup to conform to the shape of objects or to wrap around corners of objects to create an adequate seal for acquiring and securing the object.

Other types of end-effectors including vacuum cups with less flexible compliant portions (in addition to those using electrostatic attraction, magnetic attraction, needles for penetrating objects such as fabrics, fingers that squeeze an object, hooks that engage and lift a protruding feature of an object, and collets that expand in an opening of an object), are less effective at acquiring and moving a wide variety of objects.

Such applications in which a robotic system needs to accurately process a wide variety of sizes of objects relative to an environment include, for example, packing multi-unit e-commerce orders into a container, packing a single unit into an automated bagging system, packing or consolidating containers used in an automated storage and retrieval system (AS/RS), and scanning objects in front of scanners such as barcode scanners or RFID scanners.

Vacuum end-effectors, however, may be limited in their ability to acquire objects of a wide variety of sizes, such as when objects are being processed and only a small or narrow face is exposed to the end-effector. For example, bins of thin objects that are tightly packed in an input bin present certain challenges including how to properly access and grasp an object, as well as how to avoid grasping multiple objects.

There remains a need therefore, for systems and methods for more efficiently and effectively grasping, manipulating, and packing objects by efficiently acquiring objects of a wide variety of sizes without adversely impacting throughput.

### SUMMARY

In accordance with an aspect, the invention provides an object processing system with an input area at which objects are presented to a programmable motion device, the programmable motion device having an end-effector attached thereto and coupled to a vacuum source. A perception system provided perception data regarding an object to be processed at the input area and the end-effector including an elongated wedge-shaped tip at a distal end of the end-effector that is separated from a proximal end of the end-effector along a longitudinal direction of the end-effector and a plurality of apertures in a wall of the end-effector, the

plurality of apertures extending in directions that are generally transverse to the longitudinal direction.

In accordance with another aspect, the invention provides a vacuum end-effector with a rectangular applicator that includes at least two walls that extend in a longitudinal direction toward a distal end of the applicator. The distal end of the applicator includes an elongated wedge-shaped tip, and a plurality of apertures are arranged in a contact wall of the at least two walls of the end-effector, the plurality of apertures extending in directions that are generally transverse to the longitudinal direction.

In accordance with yet another aspect, the invention provides a method of processing objects using an end-effector of a programmable motion device where a plurality of objects are provided at an input area that is proximate the programmable motion device, the end-effector of the programmable motion device being detachably and selectively attached to an end-effector and coupled to a vacuum source. Perception data regarding an object to be processed that is at the input area is obtained and a distal portion of the end-effector between the plurality of objects is urged in a longitudinal direction. An object of the plurality of objects is then grasped with a vacuum force in a direction that is generally transverse to the longitudinal direction.

### BRIEF DESCRIPTION OF THE DRAWINGS

The following description may be further understood with reference to the accompanying drawings in which:

FIG. 1 shows an illustrative diagrammatic view of an object processing system including a programmable motion device with an end-effector system in accordance with an aspect of the present invention;

FIG. 2 shows an illustrative diagrammatic top view of the object processing system of FIG. 1;

FIG. 3 shows an illustrative diagrammatic enlarged view of the programmable motion device of the object processing system of FIG. 1;

FIG. 4 shows an illustrative diagrammatic further enlarged view of the end-effector of the programmable motion device of FIG. 1;

FIG. 5 shows an illustrative diagrammatic view of the input area of the object processing system of FIG. 1;

FIG. 6 shows an illustrative diagrammatic view of the end-effector of the system of FIG. 1 engaging an object being processed at the input area;

FIGS. 7A and 7B show illustrative diagrammatic exploded front (FIG. 7A) and side (FIG. 7B) views of the end-effector of FIG. 1;

FIGS. 8A and 8B show illustrative diagrammatic exploded front (FIG. 8A) and side (FIG. 8B) views of an end-effector in accordance with another aspect of the present invention that does not include a bellows;

FIGS. 9A - 9D show illustrative diagrammatic views of an end-effector coupling system for use in the object processing system of FIG. 1 in accordance with an aspect of the present invention, showing a spring-loaded pin on an end-effector attachment portion and an aperture on the end-effector (FIG. 9A), showing the pin proximate the end-effector (FIG. 9B), showing the end-effector attachment portion rotated with respect to the end-effector (FIG. 9C), and showing the pin of the end-effector attachment portion engaging the aperture of the end-effector (FIG. 9D);

FIG. 10 depicts an illustrative diagrammatic exploded view of an end-effector coupling system for use in the object processing system of FIG. 1 in accordance with another aspect of the present invention, showing an alignment feature in the end-effector and an alignment recess in the end-effector attachment portion;

FIGS. 11A and 11B show illustrative diagrammatic views of an end-effector coupling system in accordance with a further aspect of the invention, showing sets of magnets on each of the end-effector and the end-effector attachment portion (FIG. 11A) and showing the end-effector rotated and attached to the end-effector attachment portion (FIG. 11B);

FIGS. 12A and 12B show illustrative diagrammatic views of the end-effector of FIG. 1 about to grasp an object (FIG. 12A), and plunging between two objects and grasping an object (FIG. 12B);

FIG. 13 shows an illustrative diagrammatic top view of the end-effector of FIG. 1;

FIG. 14 shows an illustrative diagrammatic side view of the end-effector of FIG. 1 with the bellows cover and the vacuum applicator cover removed;

FIG. 15 shows an illustrative diagrammatic top view of the bellows portion of the end-effector of FIG. 14;

FIG. 16 shows an illustrative diagrammatic underside view of the bellows portion of the end-effector of FIG. 14;

FIGS. 17A and 17B show illustrative diagrammatic side views of the bellows portion (with alternating connected supports) of the end-effector of FIG. 14 showing the bellows without a bending force applied (FIG. 17A) and with a bending force applied (FIG. 17B);

FIGS. 18A and 18B show illustrative diagrammatic side views of the bellows portion (with alternating connected and disconnected supports) of the end-effector of FIG. 14 showing the bellows without a bending force applied (FIG. 18A) and with a bending force applied (FIG. 18B);

FIG. 19 shows an illustrative diagrammatic view of the applicator portion of the end-effector of FIG. 14 with the cover removed;

FIG. 20 shows an illustrative diagrammatic top view of the applicator portion of FIG. 19;

FIG. 21 shows an illustrative diagrammatic view of the applicator portion that includes cross-lattice openings of an end-effector in accordance with another aspect of the present invention with the cover removed;

FIG. 22 shows an illustrative diagrammatic top view of the applicator portion of FIG. 21;

FIG. 23 shows an illustrative diagrammatic view of the applicator cover of the end-effector of FIG. 1;

FIG. 24 shows an illustrative diagrammatic top view of the applicator cover of FIG. 21;

FIG. 25 shows an illustrative diagrammatic view of an applicator for an end-effector in accordance with another aspect of the invention that includes friction enhancing features in the form of bumps;

FIG. 26 shows an illustrative diagrammatic view of an applicator for an end-effector in accordance with another aspect of the invention that includes friction enhancing features in the form of strips;

FIG. 27 shows an illustrative diagrammatic view of an end-effector in accordance with an aspect of the invention positioned above a plurality of objects;

FIG. 28 shows an illustrative diagrammatic view of the end-effector of FIG. 27 having plunged into the plurality of objects so that an object may be engaged;

FIG. 29 shows an illustrative diagrammatic view of an end-effector in accordance with an aspect of the invention positioned over a container to be packed; and

FIG. 30 shows an illustrative diagrammatic view of the end-effector of FIG. 29 being used to pack the container.

The drawings are shown for illustrative purposes.

### DETAILED DESCRIPTION

In accordance with various aspects, the invention provides an end-effector system for programmable motion devices (e.g., robotic systems) that provides high flow vacuum together with gripping fingers to grasp objects. The high flow vacuum is provided at an end-effector vacuum applicator of the robotic system, and the vacuum applicator is coupled to a high flow vacuum system. The vacuum applicator is attached to a cup attachment portion, which is in turn attached to an arm attachment portion that is attached to an articulated arm of the robotic system.

Object processing systems in accordance with various aspects of the invention employ any of a variety of high flow vacuum end-effectors that are used for different objects during object processing as discussed herein. A challenge with using high flow vacuum is that if the vacuum cup contact surface contacts plural objects, the plural objects may all be grasped because the high flow vacuum system does not require that the vacuum cup tightly seal a closed contiguous surface of the object being grasped. Using a vacuum cup therefore that contacts plural objects may well grasp many of the plural objects using the high flow vacuum.

Applicants have discovered that a vacuum applicator may be provided that may wedge into spaces to separate objects and then access a side surface of an object for application of suction. Simply mounting a suction cup on a sideways mount would not provide the correct structure because standard suction cups often have bellows that are designed to provide compliance when aligning from above however this compliance when grasping from the side allows an object to create a torque that makes the grip weaker, and is difficult to use as it creates a bulky structure that cannot wedge between objects. In accordance with various aspects the invention provides an end-effector that can wedge between objects, that may grasp objects using only suction and friction from one side, that are complaint enough to conform to face of an object, and that may grasp thin objects without damaging them.

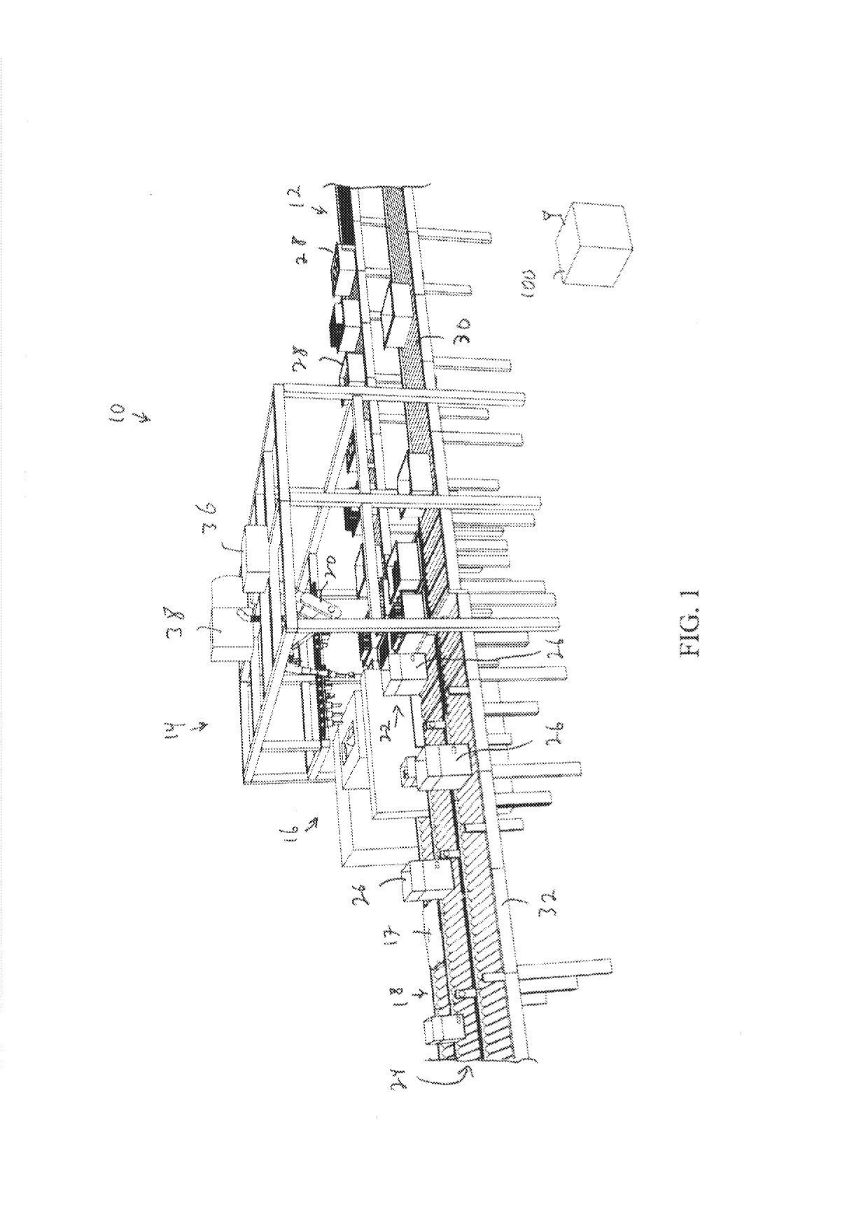

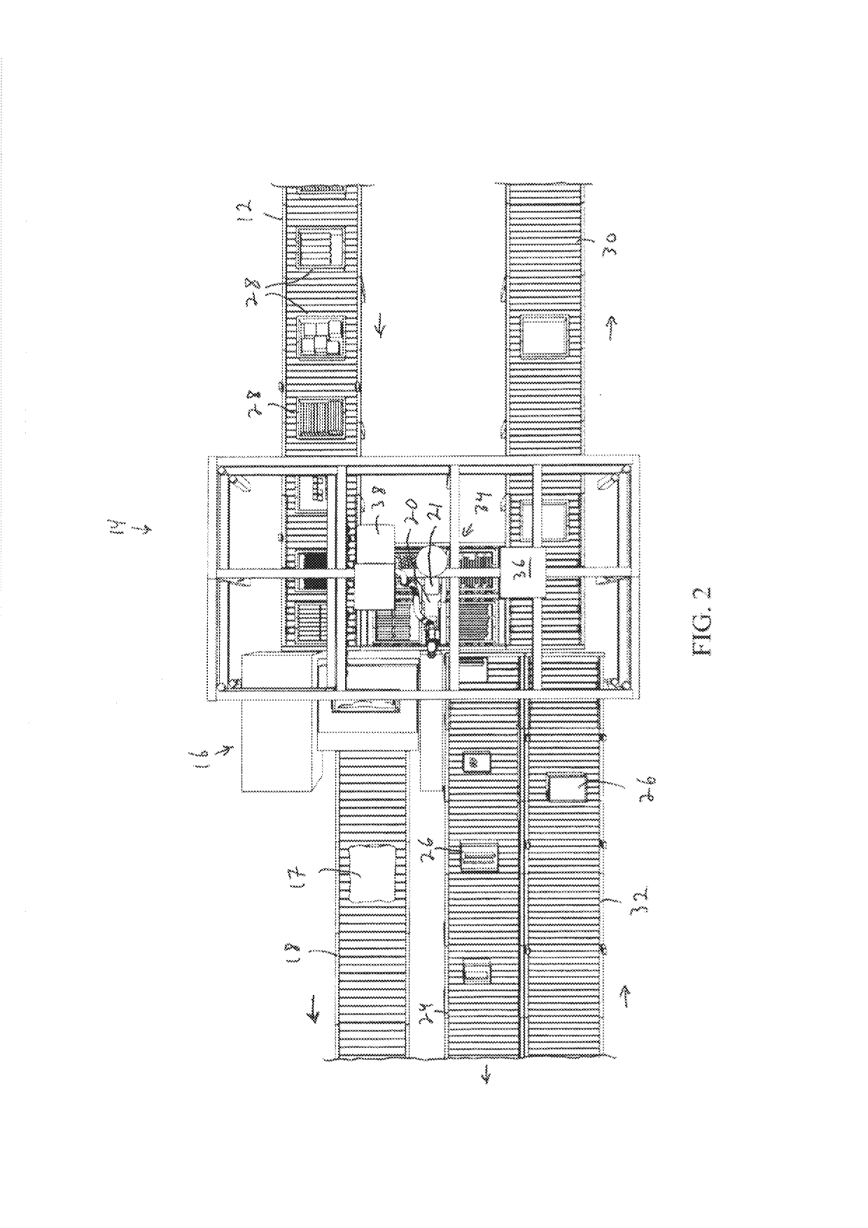

FIG. 1 shows an object processing system 10 in accordance with an aspect of the present invention that includes an input source conveyor 12 that provides objects to be processed to a processing station 14 that includes a programmable motion device 20. The programmable motion device 20 is used to grasp and move objects received at an input area 34 (shown in FIG. 2) from the input source conveyor 12, and to provide objects to any of an auto-bagging system 16 that provides objects in sealed bags 17 along an auto-bagging system conveyor 18, or to provide objects to output containers 26 (e.g., shipping boxes) provided at a packing area 22 on an container output conveyor 24. The objects to be processed may be provided in input source containers 28.

With further reference to FIG. 2, a top view shows the input source conveyor 12 that brings input objects (e.g., in bins 28) to the input area 34. The input area 34 includes two conveyor sections 52, 54 that receive objects from the input source conveyor 12, and both conveyor sections 52, 54 lead to a source container return conveyor 30 as shown in FIG. 2. Empty output containers 26 are provided along an empty output container conveyor 32 to the processing station 14, and are routed to the packing area 22 where they are packed prior to being moved along the container output conveyor 24. Operation of the conveyors and other components of the system is provided by the one or more computer processing systems 100 as discussed herein, and the programmable motion device may include its own processing control system 36 in communication with the one or more computer processing systems 100.

With reference again to FIG. 1, the programmable motion device 20 includes an end-effector attachment portion (shown in more detail in FIG. 4) that is coupled to a high flow vacuum source 38, such as for example, a side-channel blower, air amplifiers or multistage ejectors. The high flow vacuum source 38 may, for example, provide at the end-effector attachment portion 40 an air flow of at least about 100 cubic feet per minute, and a vacuum pressure of no more than about 100,000 Pascals below atmospheric, or no more than about 85,000 Pascals below atmospheric, or no more than about 65,000 Pascals below atmospheric. Again, the use of such a high flow vacuum source, while providing benefits in grasping objects where a seal is not tightly formed between the vacuum cup and the object, presents challenges in grasping only one object among a plurality of objects.

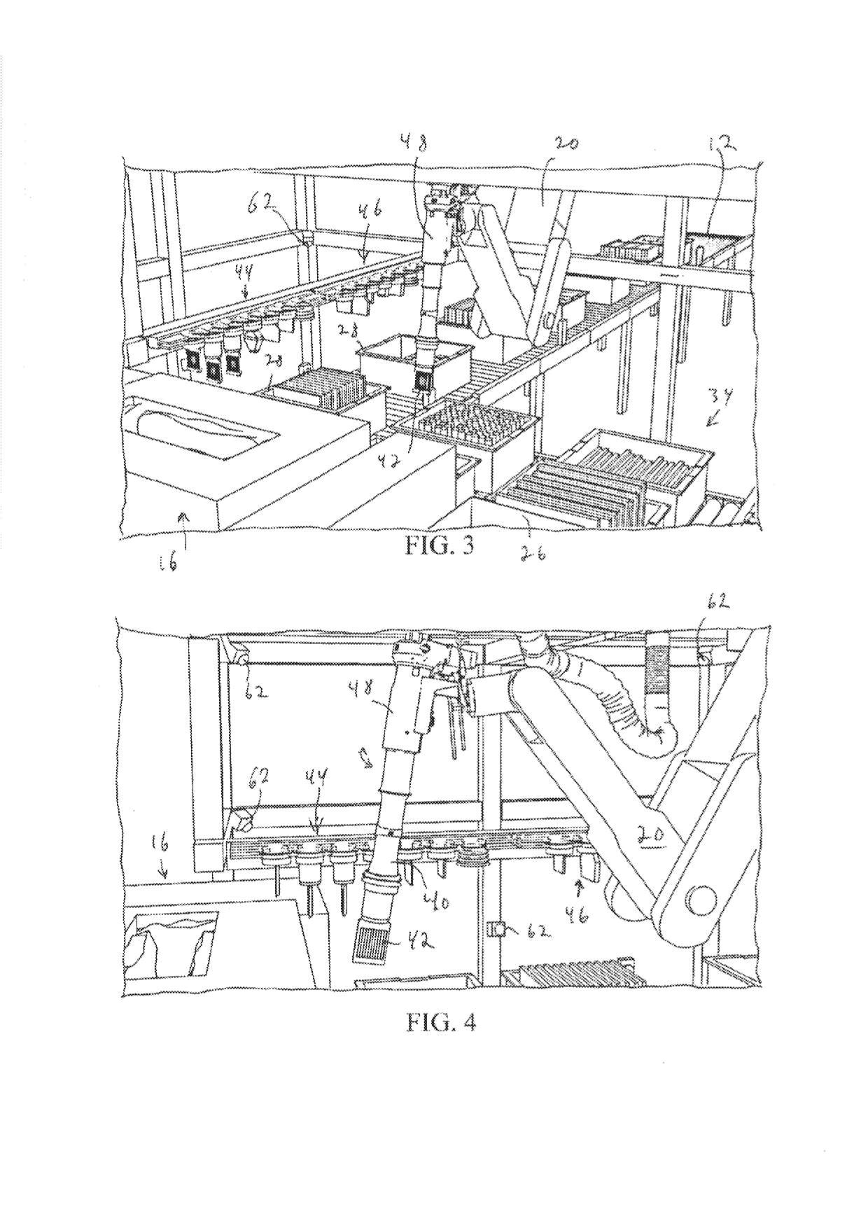

With reference to FIG. 3, an end-effector 42 may be attached to the end-effector attachment portion 40 of the programmable motion device. Plural additional end-effectors may be provided on one or more end-effector racks 44, 46 as further shown in FIG. 4. The programmable motion device is programmed to be able to engage and disengage any of the end-effectors on the racks 44, 46 as further discussed below. The end-effector attachment portion 40 is mounted within a collar 48 that is attached to the programmable motion device 20, and an opposite end of the end-effector attachment portion (that extends out the other side of the collar 48) is coupled to a vacuum hose 50 that is coupled to the vacuum source 38.

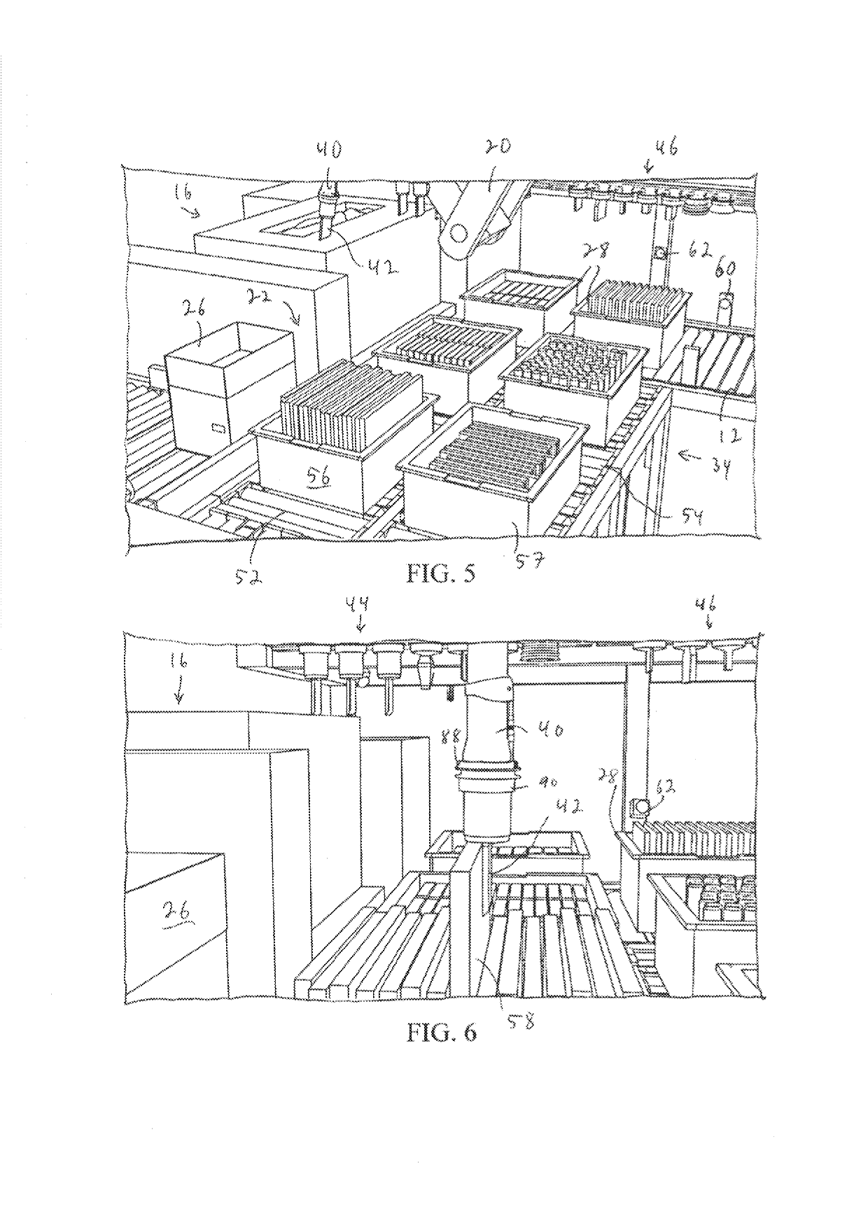

As shown in FIG. 5, exemplary objects to be processed by the system may come in a variety of sizes with a variety of exposed face sizes available for grasping. The input area 34 in FIG. 5 includes the two conveyor sections 52, 54, both of which may be accessed by the end-effector of the programmable motion device. In certain applications, each conveyor section may further include right-angle-transfer mechanisms (e.g., raisable belts) to move containers between the conveyor sections 52, 54. An input container, e.g., container 56, may include objects with a large aspect ratio but with small-sized faces exposed to the programmable motion device. In accordance with an aspect of the present invention, the system may select an end-effector (e.g., 42) to be used to grasp an object 58 from the input container 56 as shown in FIG. 6. A perception system (e.g., including perception units 62 and perception unit 21 shown in FIG. 2) provide perception data regarding an object to be processed that is in the input area, and the perception data includes data that is representative of an exposed face of the object. The system may include conveyor perception units 60 along the input source conveyor 12 as well as the perception units 62 on the support structure from which the programmable motion device is suspended for aiding (together with the computer processing systems 36, 100) in operation of the programmable motion device of grasping, moving and placing objects into any of, for example, output containers 26 or sealed bags 17 as discussed herein.

In accordance with various aspects, the invention provides a new form of suction applicator (cup) in which a wedged tip is integrated with a rectangular structure and a side facing opening, and the applicator is mounted to a flexible bellows between the applicator and the rest of the vacuum system, permitting the flexible bellows to bend and flex along two or more axes, but the bellows has limited compressibility and is rigid to torsional forces. In the side cup surface, there is a reinforced lattice work that allows air to pass through to create suction while preventing a large gap from forming. The reinforced lattice work inhibits thin surfaces from being damaged when sucking into the side of the suction cup. Achieving a good grasp requires a seal against the entire surface of the suction cup or nominally against most of the surface to provide more even distribution. It is preferred that an air channel be sent down the side of the entire cup and then the latticework extends sideways from that channel. This allows for a progressive closing of the vacuum line, which increases the ability of the suction cup to avoid partial picks. The flexible bellows are optional and are designed to allow the suction cup to deform as it conforms to an object. The flexible bellows are also designed to not compress so substantially and become rigid when activated. The thin profile of the suction cup allows for the object to be wedged in between surfaces and then connected to vacuum.

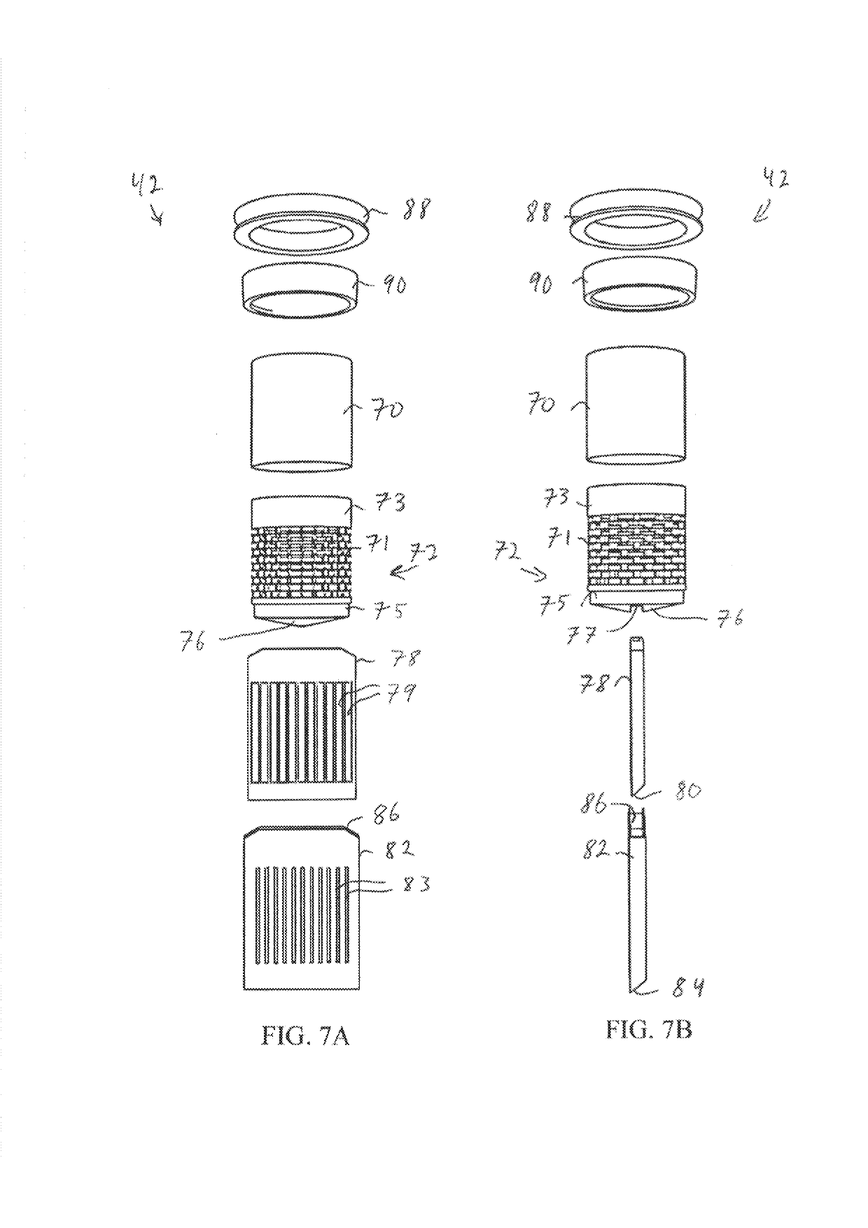

As shown in FIG. 6, each end-effector includes an annular mounting ring 88 for engagement with the rack structures 64 and for engagement with end-effector attachment portion 40 of the programmable motion device 20. Each end-effector also includes a coupling collar 90 that is attached to each annular mounting ring 88 as well as to each vacuum port. With reference to FIGS. 7A and 7B, the annular mounting ring 88 is attached to the coupling collar 90, to which is attached a bellows 72 that includes a bellows cover 70. The bellows includes a proximal portion 73 that attaches to the mounting collar 90, a bellows structure 71 and a distal portion 75 to which a cover 76 is mounted. FIG. 7A shows a front view and FIG. 7B shows a side view. As shown in FIG. 7B, the cover 76 includes s slot opening 77 into which a proximal end of the applicator 78 is attached. The applicator 78 includes elongated apertures on a front side thereof (as shown in FIG. 7A) as well as an elongated wedge-shaped distal portion 80 and 84 (as shown in FIG. 7B). The applicator 78 is covered by an applicator cover 82 that includes an opening 86 at the proximal end (as shown in FIG. 7B), and applicator cover apertures or openings 83 on a front side wall thereof (as shown in FIG. 7A). The elongated wedge-shaped tip 80 includes a wedge angle of between about 50º from a longitudinal direction of the end-effector to 15 º from the longitudinal direction of the end-effector. The bellows cover 70 and the applicator cover 82 may be formed of a flexible compliant material, and serve to contain the vacuum within the end-effector such that the vacuum is provided at the applicator cover openings 83 on the front side of the end-effector 42. The bellows structure 71 provides that the bellows 72 is resistant to compressive forces and torsional (yaw) forces, but is complaint in roll and pitch directions as discussed in more detail below. The use of the bellows 72 (and bellows cover 70), however, is optional.

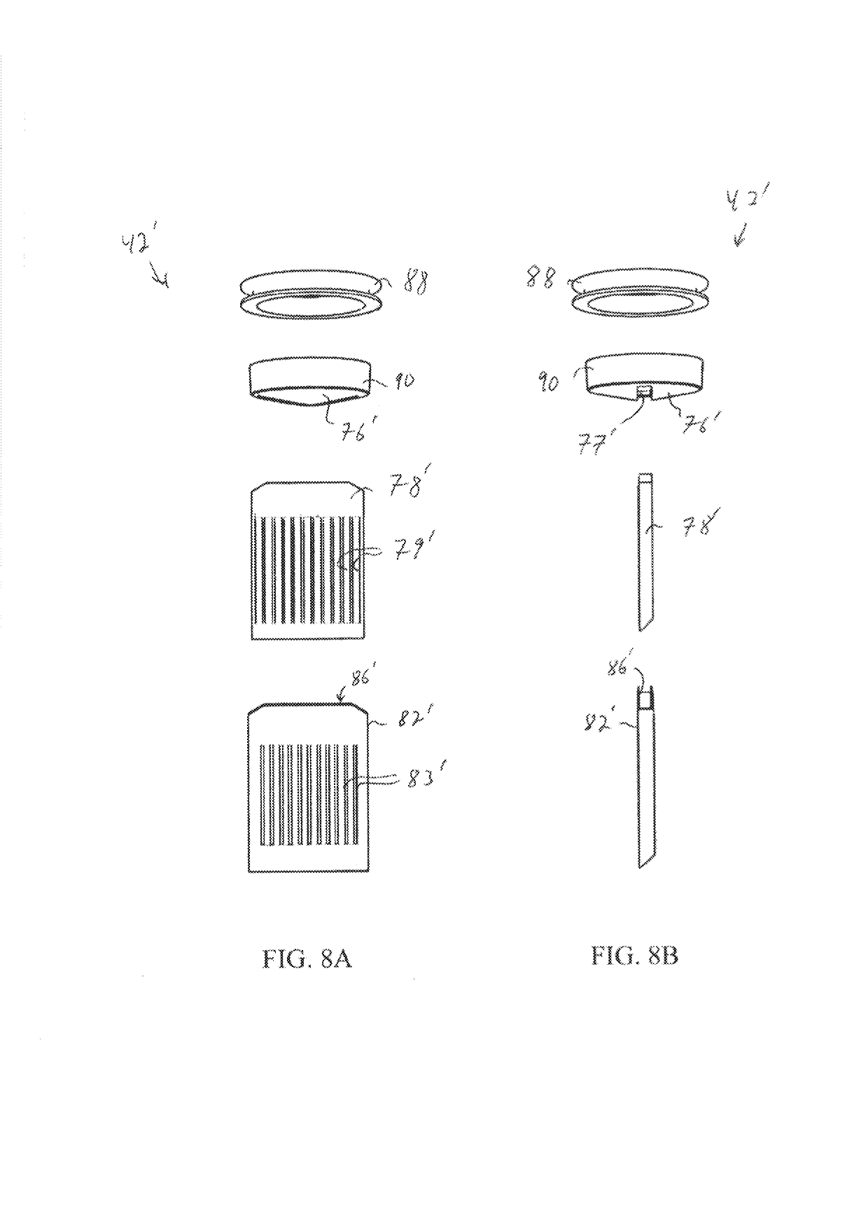

FIGS. 8A and 8B show an end-effector 42’ in accordance with another aspect of the invention that does not include a bellows 72 (or bellows cover 70). In the end-effector 42‘, the annular mounting ring 88 is attached to the coupling collar 90, to which is attached a cover 76’ that includes s slot opening 77’ into which a proximal end of the applicator 78’ is attached. The applicator 78’ includes elongated apertures on a front side thereof (as shown in FIG. 8A) as well as a wedge-shaped distal portion 80’ (as shown in FIG. 8B). The applicator 78’ is covered by an applicator cover 82’ that includes an opening 86’ at the proximal end (as shown in FIG. 8B), and applicator cover openings 83’ on a front side thereof (as shown in FIG. 8A). The applicator cover 82’ may be formed of a flexible compliant material, and serves to contain the vacuum within the end-effector such that the vacuum is provided at the applicator cover openings 83’ on the front side of the end-effector 42’.

The coupling of each end-effector to the end-effector attachment portion may be provided, for example, by engaging magnets on one part with a ferromagnetic metal (or complementary magnets) of the other part. Because the vacuum is applied on one side only of the end-effector (and because the end-effector includes an elongated wedge surface), the system needs to engage each end-effector at an orientation that is known.

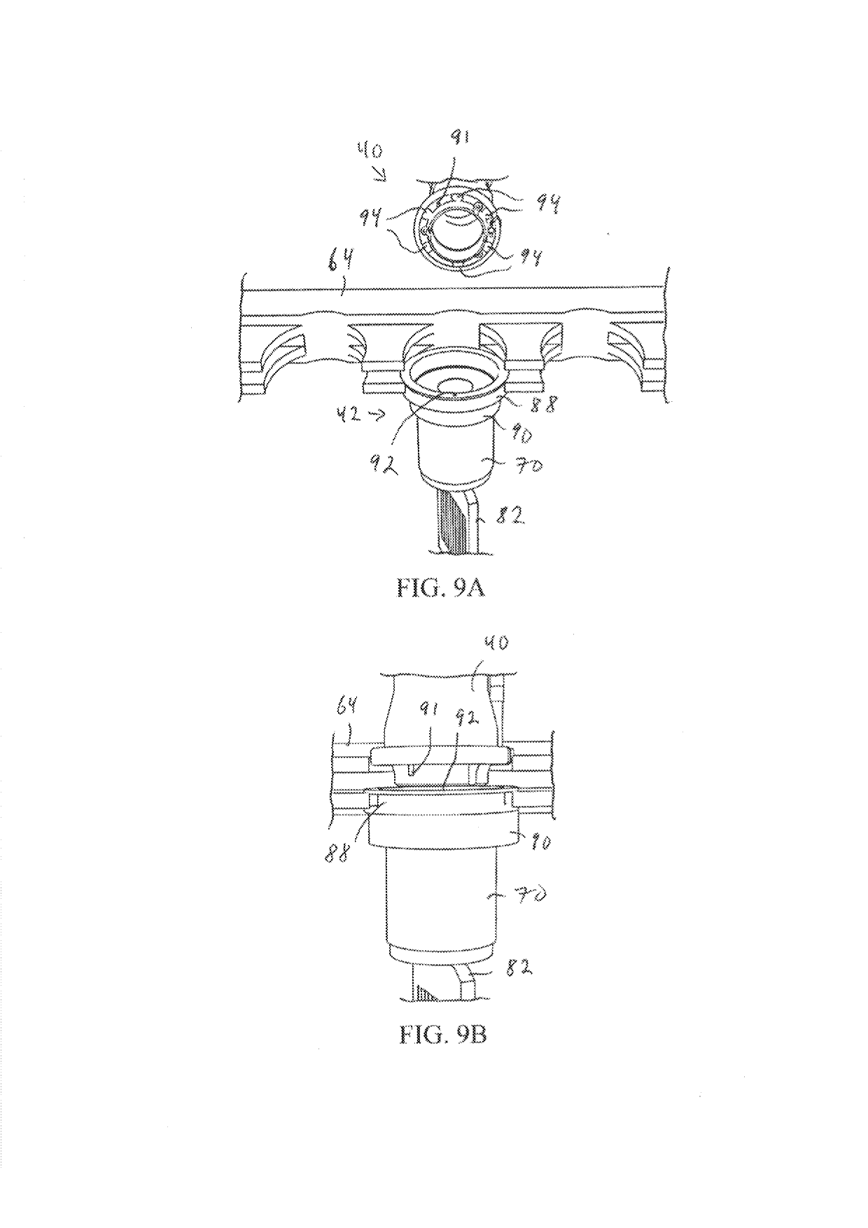

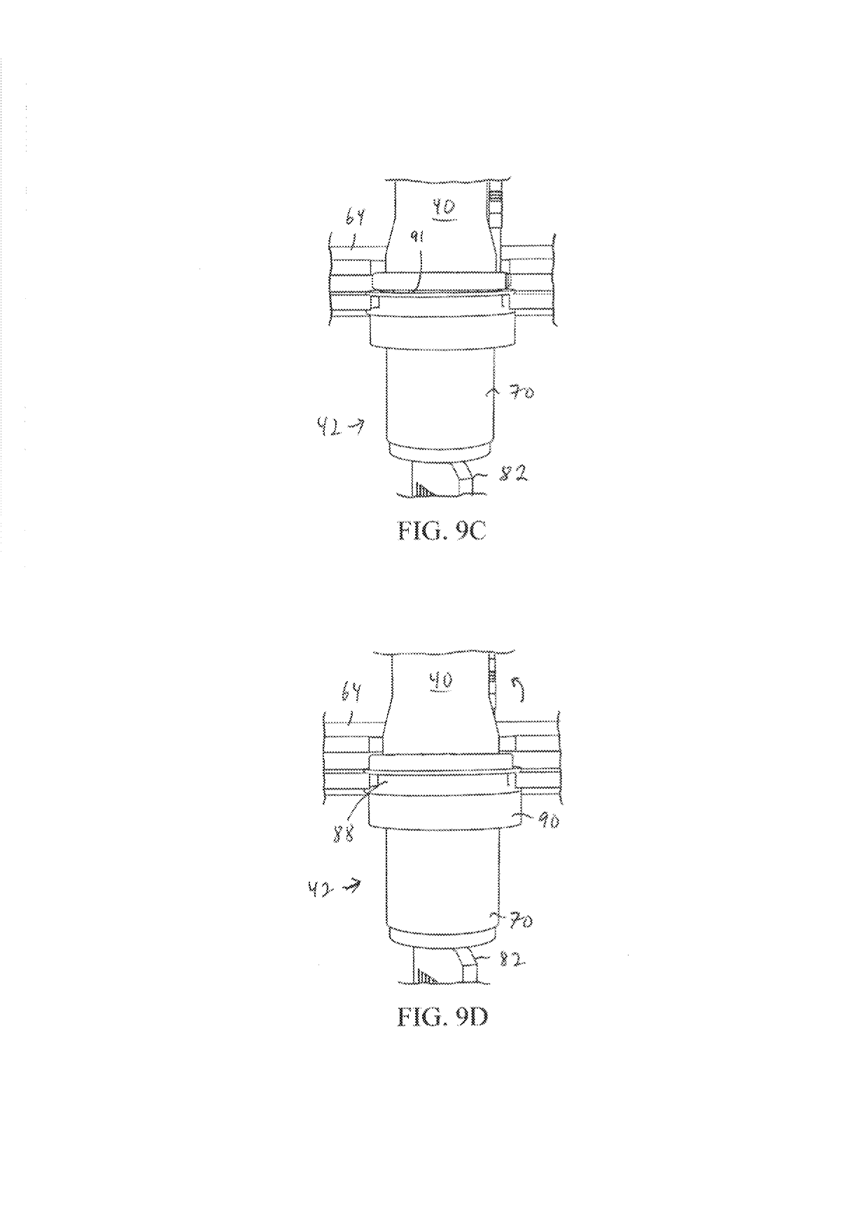

FIGS. 9A - 9D for example, show an engagement system that includes a pin and a pin recess for alignment of the end-effector on the attachment portion. With reference to FIG. 9A, a spring-loaded pin 91 is provided on the attachment portion, and a pin recess 92 is provided on the annular mounting ring 88. During use in attaching the end-effector, the programmable motion device positions the attachment portion 40 above the end-effector on the rack, wherein the pin 91 and the recess 92 are not yet aligned (FIG. 9B). The attachment portion is lowered further, and the pin contacts the annular mounting ring 88 (FIG. 9C). The end-effector attachment portion is then rotated until the pin 91 engages the pin recess 92 (FIG. 9D). The retracted position of the pin 91 (shown in FIG. 9C) is designed such that the magnetic fields of the magnets 94 are not yet so strong as to inhibit rotation of the attachment portion with respect to the end-effector. In accordance with further aspects, the magnets 94 may be provided as electromagnets that may be engaged only when the pin has been received within the pin recess (FIG. 9D). In this example, the attachment portion rotates until it is aligned with the end-effector on the rack.

In accordance with another aspect, alignment of the coupling of each end-effector 42 to the end-effector attachment portion 40 is provided by an alignment feature 191 that engages with an alignment recess 192 provided in the end-effector attachment portion when rotationally aligned, as depicted in an exploded view as shown in FIG. 10. The alignment feature 191 may be provided on an insert 194 that is captured within the end-effector 142 with the annular mounting ring 188 that is threaded into a threaded receptacle of the end-effector 142. An O-ring 198 may be provided to minimize vacuum leakage through the threads of the threaded annular mounting ring 188 and the end-effector 142. Furthermore, a mesh screen insert 196 may be optionally provided to minimize the potential for introducing debris into the vacuum system during operation. During use in attaching the end-effector 142 to the attachment portion 40, the programmable motion device positions the attachment portion 40 above the desired end-effector on the rack, without a priori knowledge of the orientation of the desired end effector in the rack. The attachment portion 40 is lowered, and if the alignment is not established, the alignment feature 191 fails to engage in the alignment recess 192, causing resistance to movement. The programmable motion device then rotates the attachment portion 40 until the resistance is minimized, where the alignment feature 191 engages into the alignment recess 192 causing the magnets 94 (described above) to provide the attachment force attaching the end-effector 142 to the attachment portion 40.

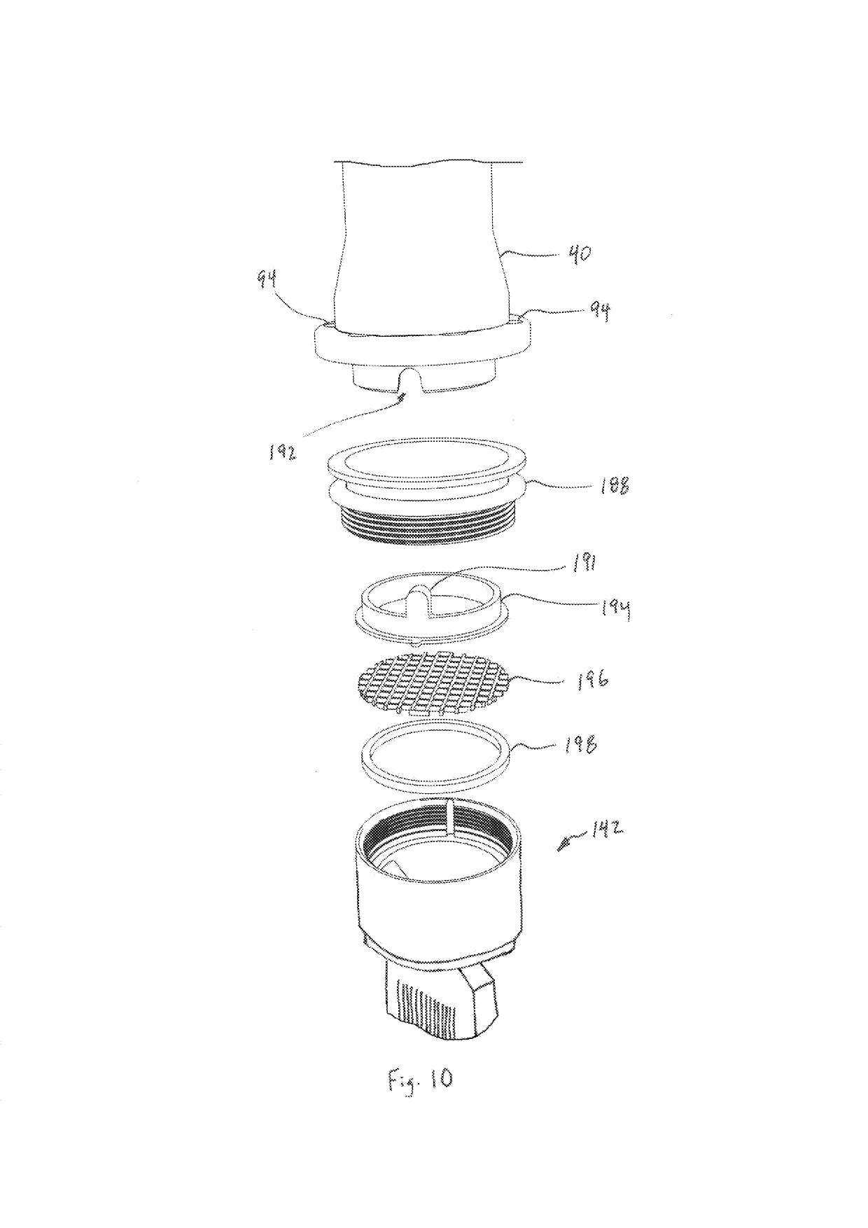

In accordance with further aspects, the magnets used for engaging the attachment portion to the annular attachment ring of the end-effector may themselves effect proper alignment of the end-effector with the attachment portion. FIGS. 11A and 11B, for example, show another attachment portion 40’ that includes s-magnets 94 and n-magnets 96, while the end-effector 42’ includes n-magnets 95 and s-magnets 97. FIG. 11A shows the magnets, and FIG. 11B shows the attachment portion 40’ coupled to the end-effector 42’, showing that the end-effector 42’ has been rotated under the polar forces of the magnets to both align with and engage the end-effector 42’ with the attachment portion 40’. The n-magnets align with the s-magnets, so irrespective of the original orientation of the end-effector with respect to the attachment portion, the parts will come together in one of either of two mutual orientations that are 180º apart; either of these mutual orientations works because the end-effectors are symmetric. In accordance with further aspects, sets of magnets may be used that couple only in a single respective orientation of each end-effector and the attachment portion. In accordance with certain aspects, the attachment portion 40’ may also (or instead) be rotated to the alignment position. In each of the systems of FIGS. 9A - 11B, the control system may know or confirm the identity of each end-effector either by a scanner or camera system that detects a code on each end-effector or by providing low level magnets that detect low level distinct field patterns identifying each end-effector.

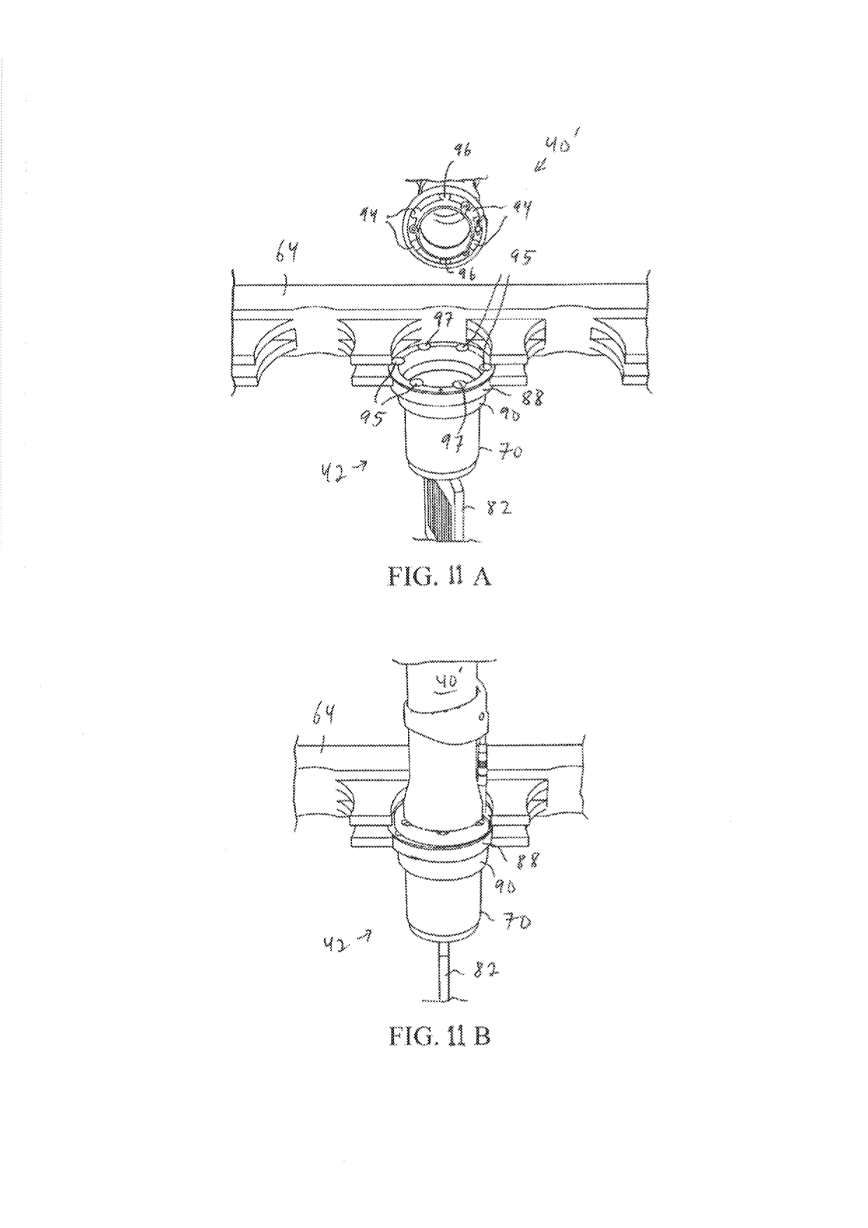

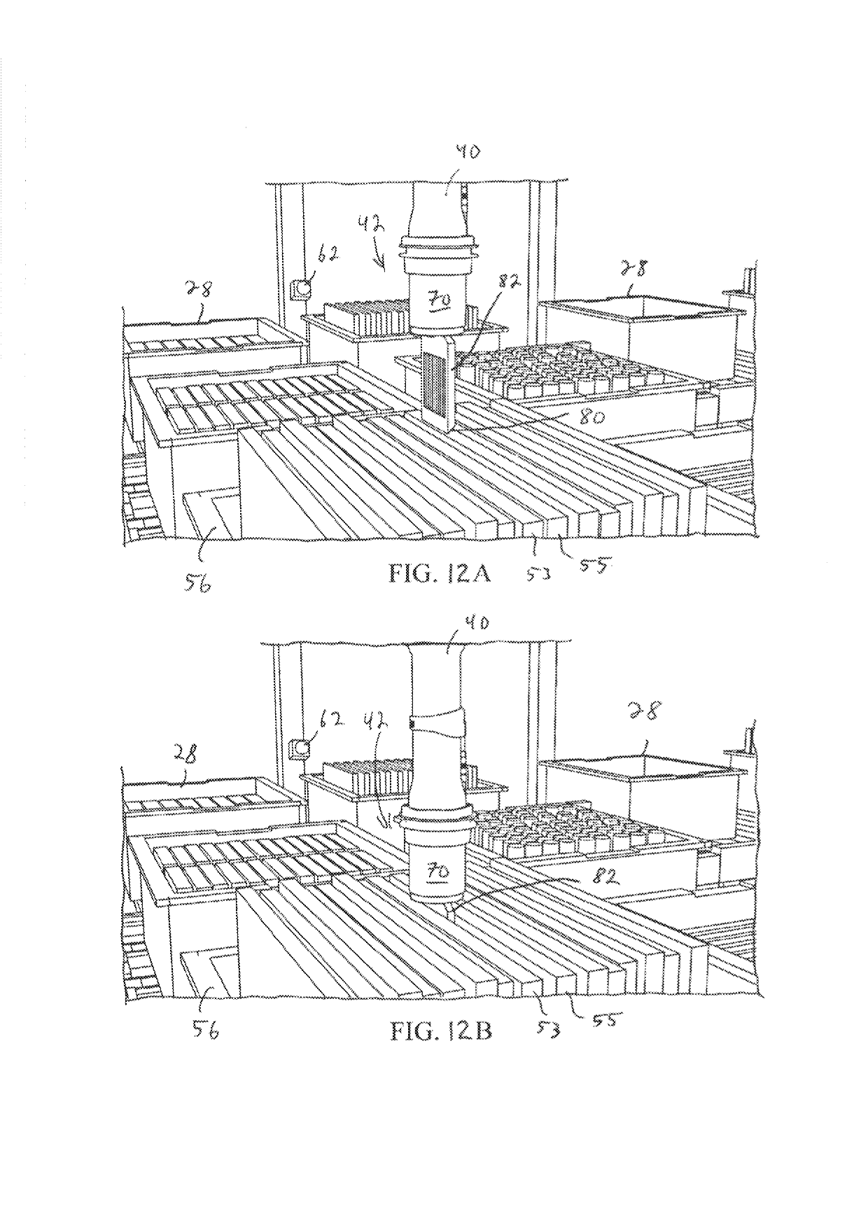

The wedge-shaped distal portion 80 of the end-effector 42 may be used to plunge between objects in an input container such as input bin 56 shown in FIG. 12A. Objects 53 and 55 are positioned close to each other in the tightly packed input bin 56. The wedge-shaped distal portion 80 of the end-effector 42 is inserted between the objects 53 and 55 and pushes the objects apart sufficient for the distal portion 80 to move down between the objects 53 and 55 as shown in FIG. 12B. The high flow vacuum is on during the insertion process, and the vacuum force applied to the object 53 increases as the applicator and cover 82 moves downward, increasing the amount of the applicator (and cover) openings that are adjacent the object 53. Through force feedback (sensing resistance) on the end-effector 42, the system will determine when the applicator (through the cover) have a strong grasp on the object 53 and will cease moving the end-effector downward. The object 53 is then lifted from the bin 56 and processed by either placing the object into either an output container 26 or into the bagging station 16 as discussed above.

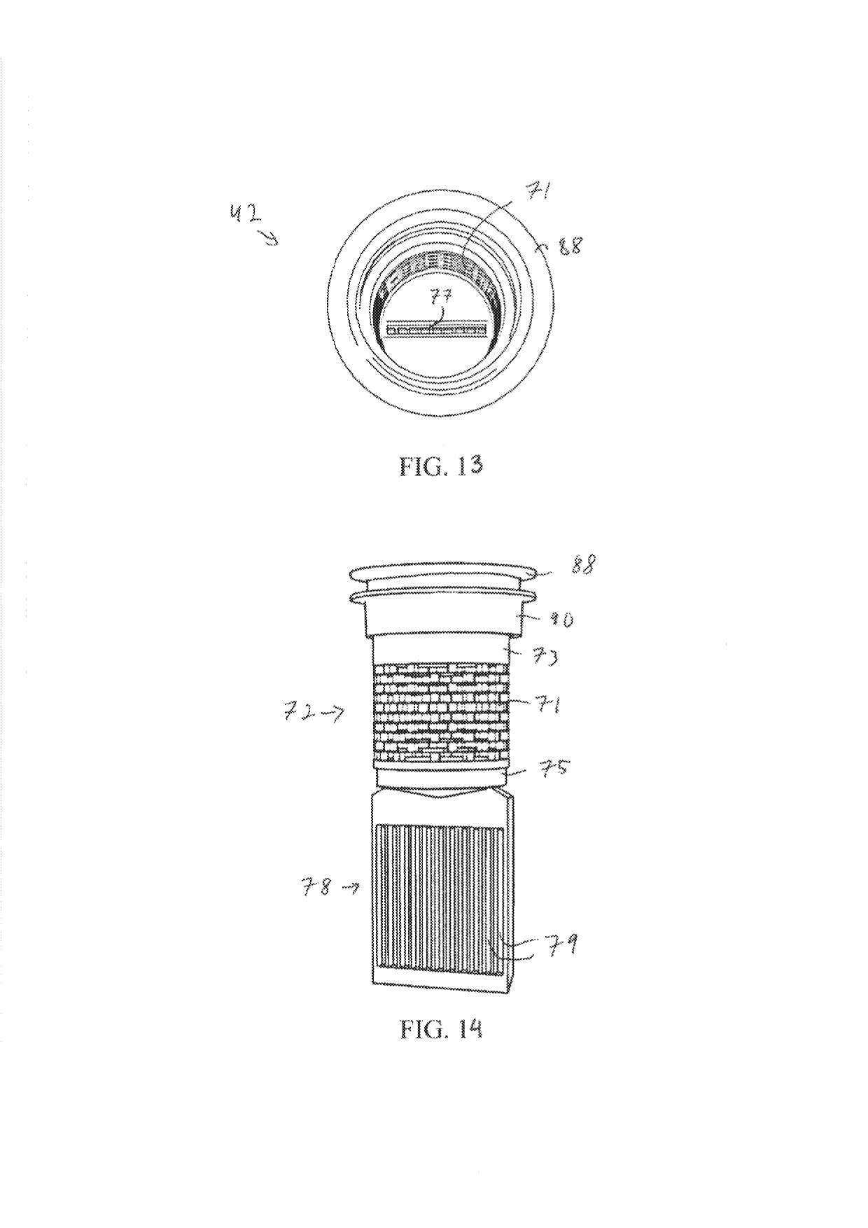

The vacuum is drawn up through the applicator 78 (and bellows 42 when present). FIG. 13 shows a top view of the end-effector 42 with the annular mounting ring 88 providing an opening through which the vacuum is drawn through the slot opening 77 of the cover 76. The slot opening 77 is in communication with the interior of the applicator 78. FIG. 14 shows the end-effector 42 with the bellows cover removed and with the applicator cover removed. The bellows 72 is attached at its proximal end 73 to the collar 90 which is attached to the annular mounting ring 88. The bellows 72 includes the bellows structure 71 (discussed in more detail below) that inhibits compression and differential torsional movement of the bellows while permitting bending of the bellows structure 71. The bellows 72 also includes the distal portion 75 that is coupled to the applicator 78, which includes the applicator openings 79 through which the vacuum is applied to an object to be grasped.

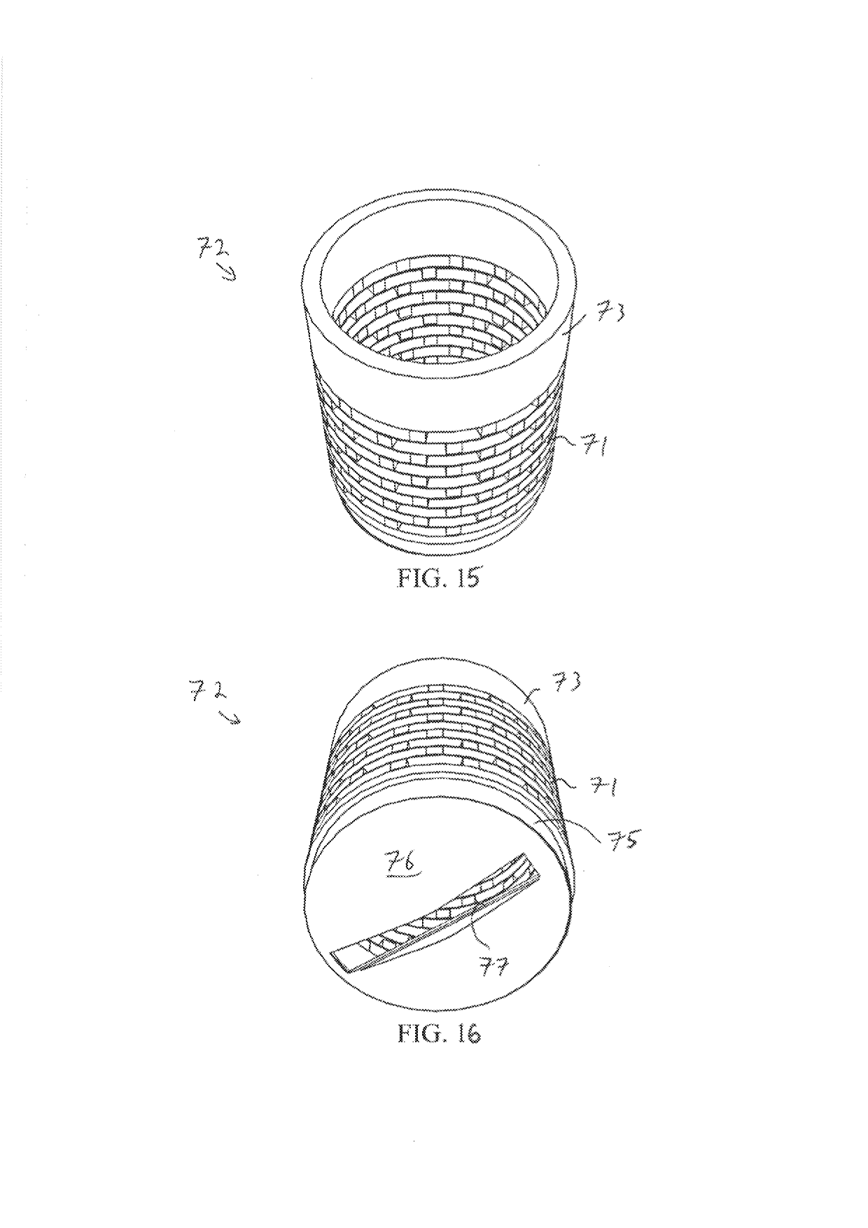

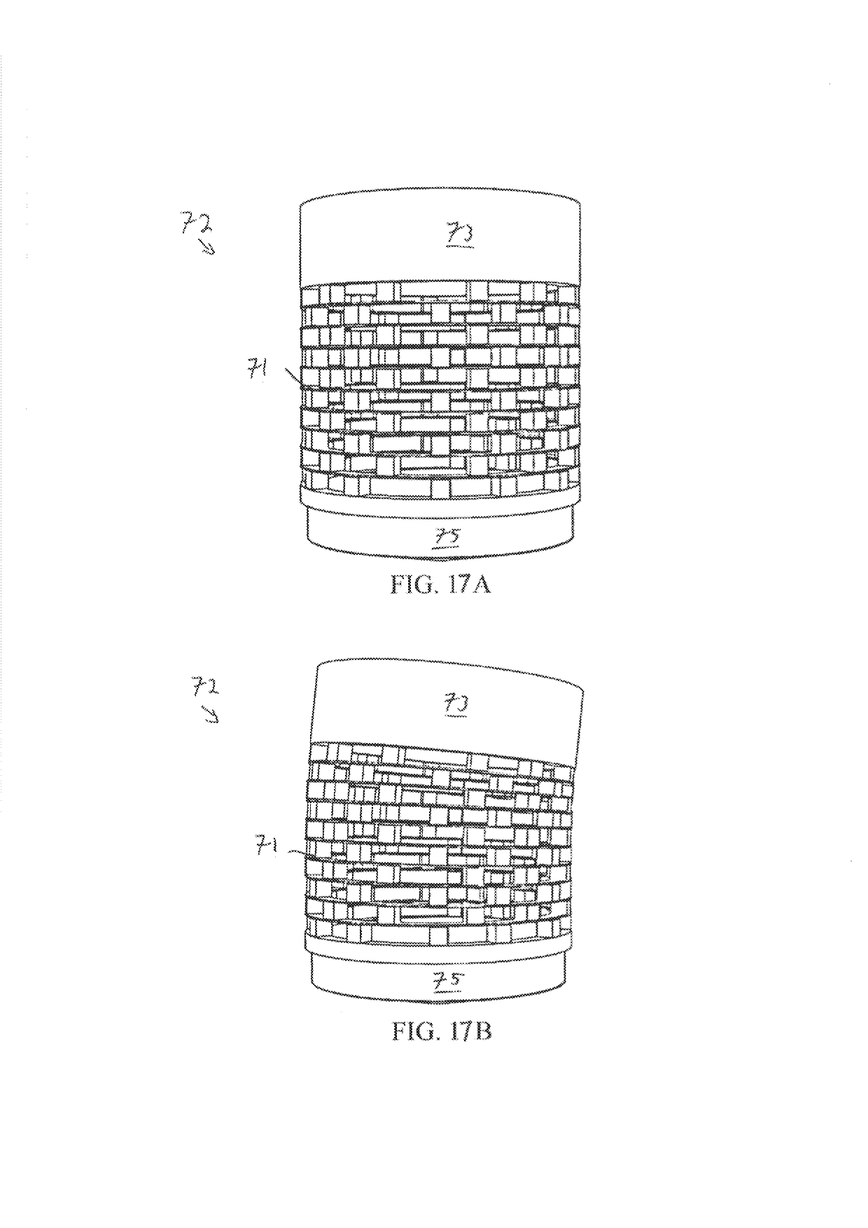

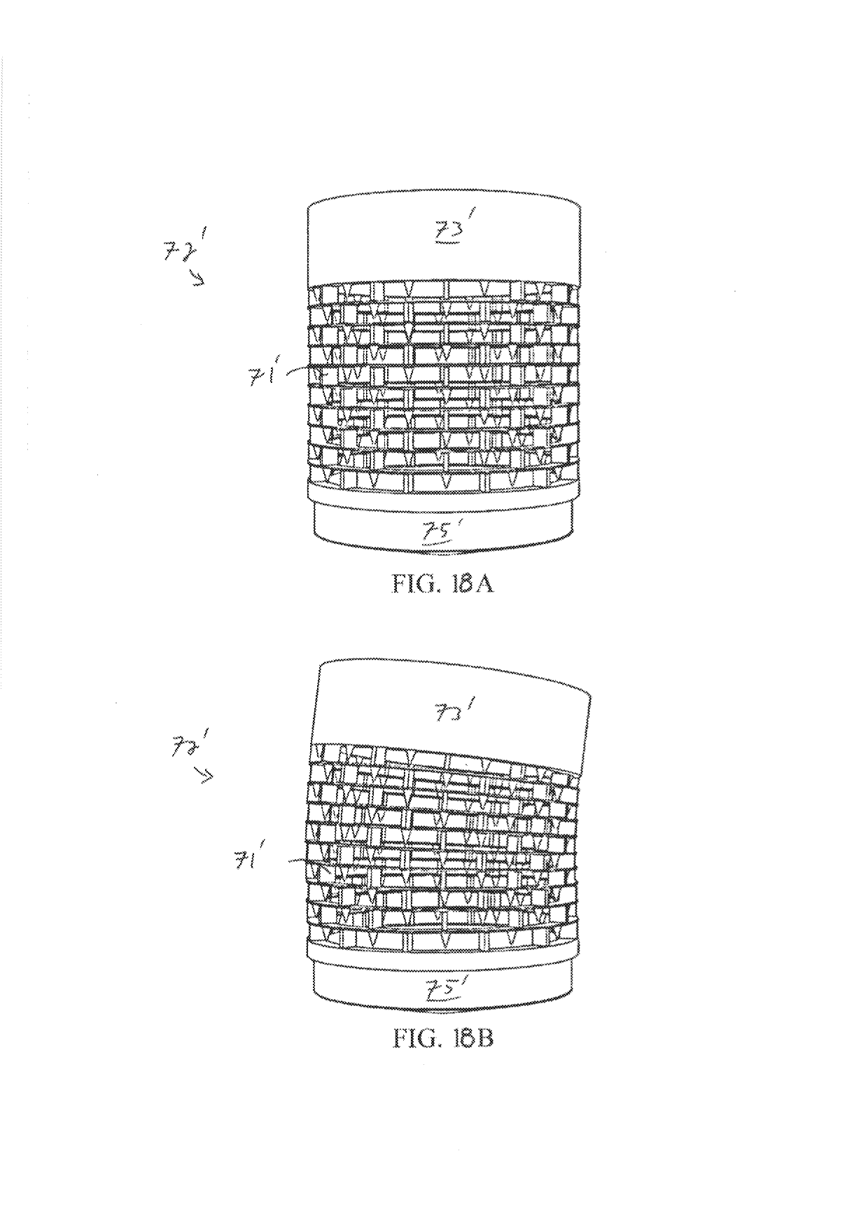

FIG. 15 shows a top elevated view of the bellows 72, showing the opening at the proximal end 73 and the bellows structure 71, which includes annular rings separated by alternating supports that are fixed to the rings. FIG. 16 shows an underside view of the bellows 72, showing the cover 76 and the slot opening 77 in the cover into which the proximal portion of the applicator is coupled. Due to the alternating arrangement of the supports, the bellows 72 is able to bend slightly under a bending force. FIG. 17A show the bellows 72 without application of any bending force, and FIG. 17B shows the bellows 72 when subjected to a bending force. The supports between the annular rings may also be slightly compressible when more force is applied to a smaller number of them (such as when the bellows 72 is bending), and less compressible when the force is distributed over all of the supports (such as when the bellows 72 is in compression).

FIG. 18A shows a bellows 72’ in accordance with a further aspect of the invention in which the bellows 72’ includes a bellows structure 71’ with alternating fixed and partial supports (shown as inverted cones). The partial supports are fixed at their bases but are not fixed to a ring at their peaks. Again, a proximal portion 73’ is attached to the collar 90 and a distal portion 75’ is coupled to an applicator. The distal end 75’ of the bellows 72’ is coupled to an applicator. FIG. 18B shows the bellows 72’ bending under a bending force. As compared to the bellows 72 of FIGS. 17A and 17B, with half of the supports not being fixed to both its upper and lower rings, the bellows 72’ should bend a little more as compared to the bellows 72, but may not exhibit any more compression than that of the bellows 72 (if for example, the compression of half the supports in the bellows 72 is sufficient to withstand compressive forces distributed over all of the supports).

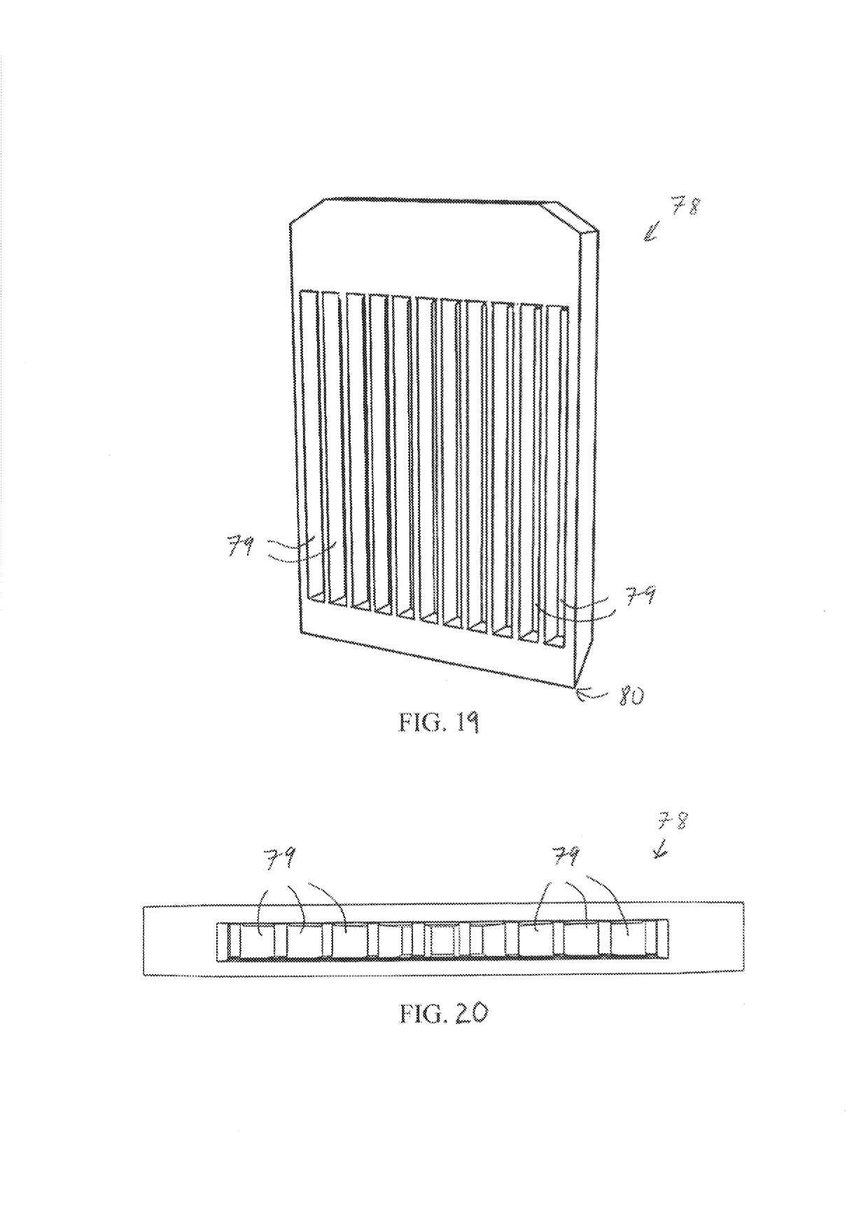

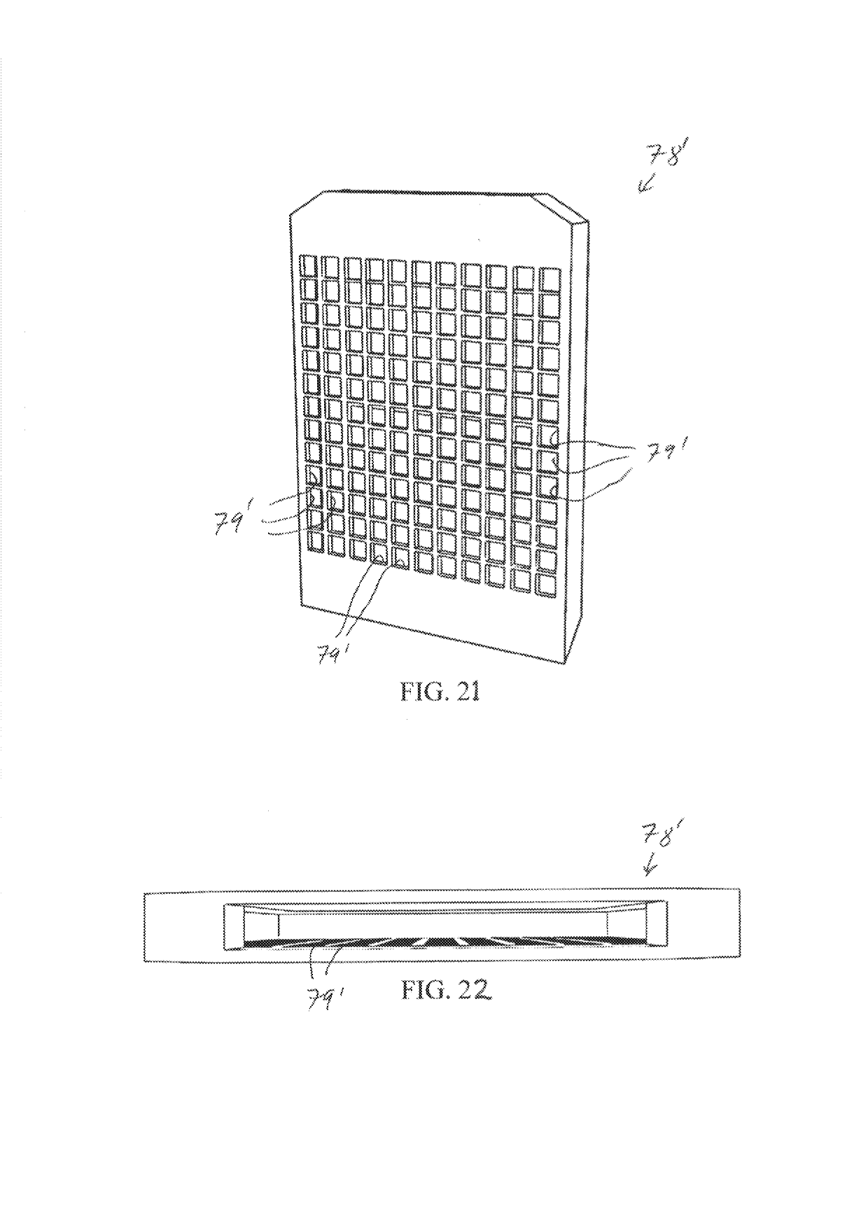

The applicator 78 is also rigid to compression and includes the wedge-shaped distal portion 80 as well as the lattice openings 79 as shown in FIG. 19. With reference to FIG. 20, the proximal portion of the applicator 78 includes the proximal opening that is in communication with the lattice openings 79. Again, the lattice openings may be in the form of elongated apertures. In accordance with further aspects, an applicator 78’ may also be rigid to compression and include the wedge-shaped distal portion 80’ as well as lattice openings 79’ that are provided as a plurality of small-sized openings (e.g., an array of square or circular openings) as shown in FIG. 21. With reference to FIG. 22, the proximal portion of the applicator 78’ includes the proximal opening that is in communication with the lattice openings 79’.

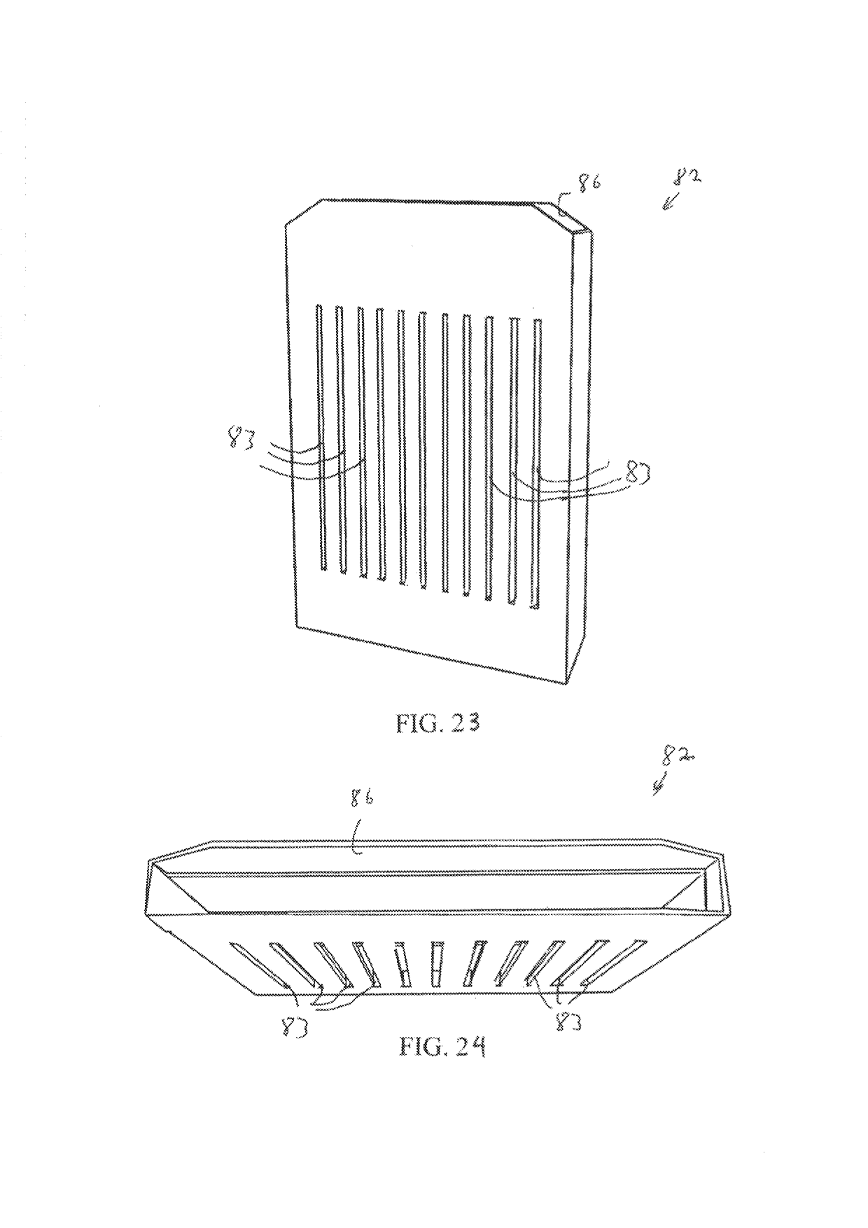

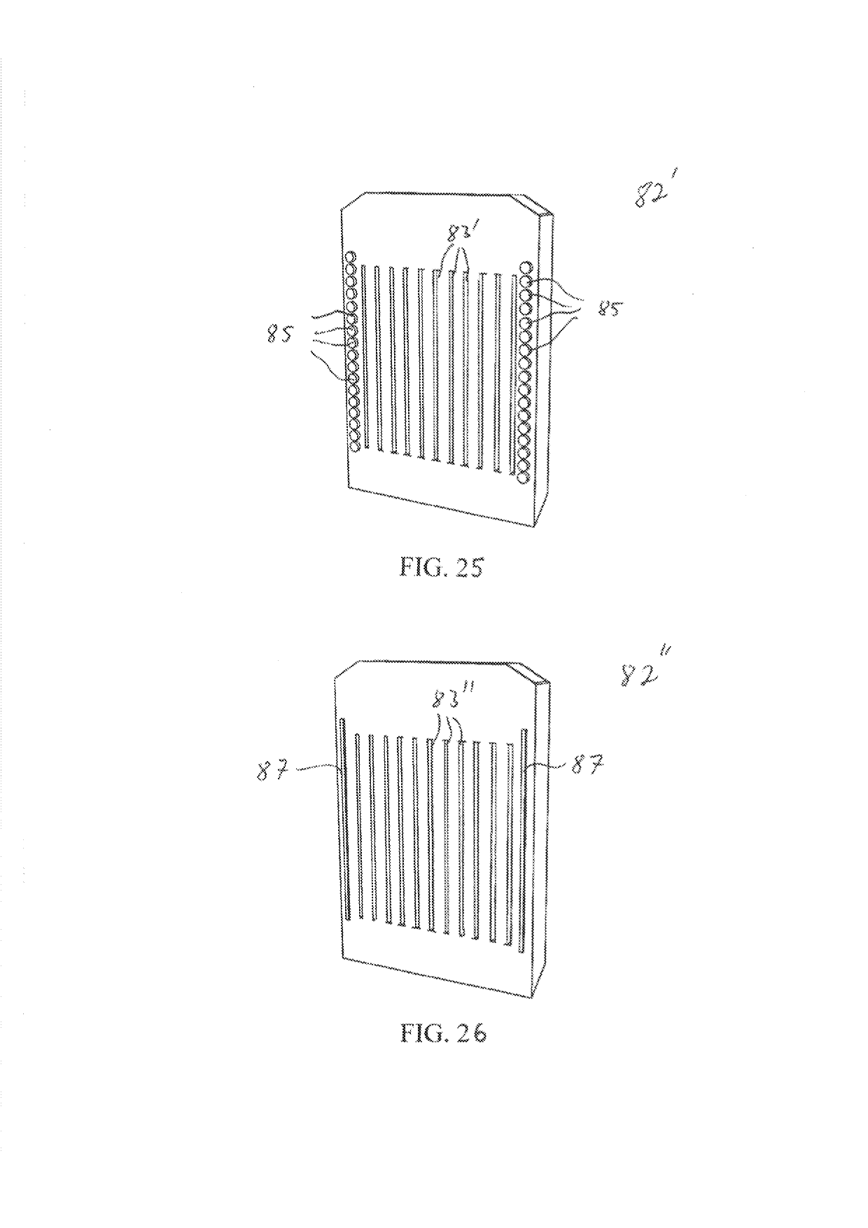

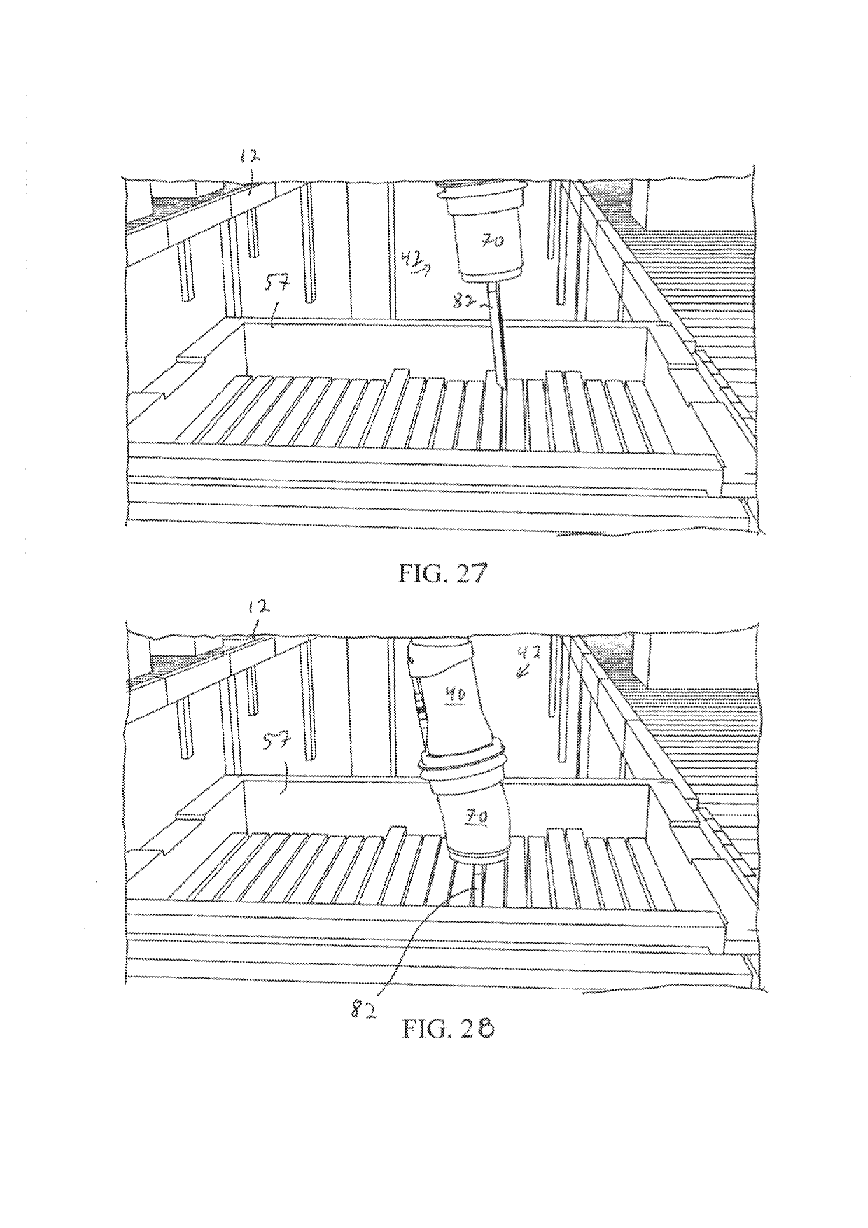

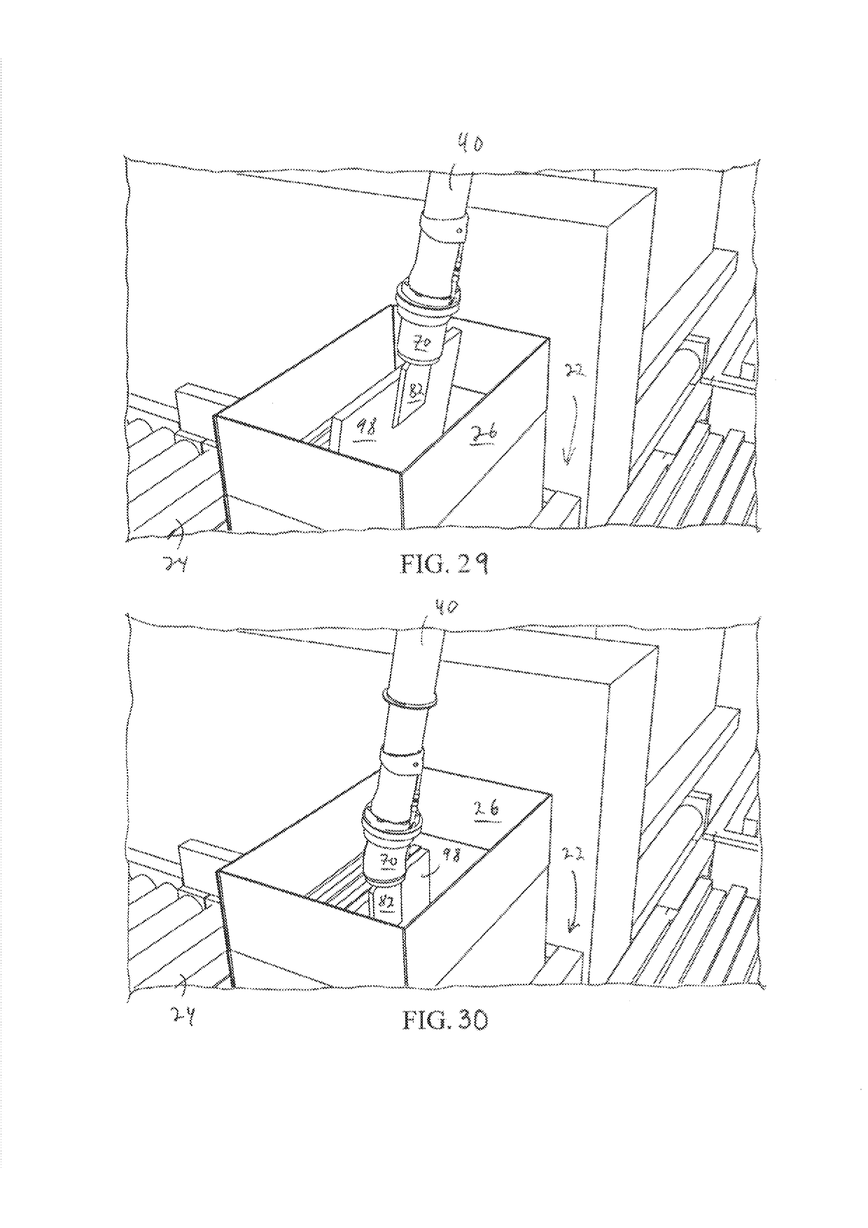

Similarly, as shown in FIG. 23, the flexible applicator cover 82 includes a distal portion that cover the portion 80 of the applicator, and an opening 86 that is also in communication with applicator cover openings 83 that are aligned with the applicator lattice opening 79. The applicator cover openings 83 may be narrower than the associated applicator lattice openings 79. Similarly, FIG. 24 shows the proximal portion of the applicator cover 82 that includes the proximal opening 86 that is in communication with the cover openings 83.

In accordance with further aspects, the applicator cover may include friction-enhancing features. For example, FIG. 25 shows an applicator cover 82’ that includes apertures 83’ as well as two rows of a plurality of friction-enhancing features 85 such as discs or mounds. FIG. 26 shows an applicator cover 82’’ that includes apertures 83’’ as well as two rows of friction-enhancing strips 87. Once the vacuum fully engages an object to be lifted, the friction-enhancing features 85, 87 may further improve a grasp on the object. In accordance with further aspects, if the vacuum seal between the bellows and the applicator (or between the collar and the applicator where no bellows is used), is pneumatically secured, it may be unnecessary to use an applicator cover, and the applicator without a cover may be used to plunge between objects and grasp an object. In this case, the friction-enhancing features 85 or 87 may be provided on the applicator itself.

The bending of the bellows (as discussed above) may facilitate engagement of the applicator (through the applicator cover) with an object to be grasped. For example, FIG. 27 shows the end-effector 42 above a plurality of objects in an input bin 57. The programmable motion device is extending the end-effector 42 to reach over the objects, and is not approaching the objects from a direction that is normal to the exposed surfaces of the objects. When the applicator (and the applicator cover 82) are plunged in between objects (as shown in FIG. 28), the bellows (and bellows cover 70) bend to permit the applicator (and applicator cover 82 when used) to align with the space between the objects, facilitating engagement of a selected object.

In accordance with yet further aspects, end-effectors in accordance with the above and further aspects of the present invention may be used for packing output containers. FIG. 29, for example, shows the end-effector 42 grasping an object 98 (e.g., with an applicator through the applicator cover 82) prior to placement into an output container 26 that is positioned at the packing area 22. With further reference to FIG. 30, when the end-effector 42 is used to urge the object 98 against other objects already packed in the output container 26, the bellows (and bellows cover 70) may bend facilitating packing of objects into the output container 26. In accordance with further aspects, the use of end-effectors of various aspects of the present invention may facilitate packing even without the bellows.

Those skilled in the art will appreciate that numerous modifications and variations may be made to the above disclosed embodiments without departing from the spirit and scope of the present invention.

1. An object processing system comprising:
an input area at which objects are presented to a programmable motion device, the programmable motion device including an end-effector attached thereto that is coupled to a vacuum source;
a perception system for providing perception data regarding an object to be processed that is at the input area; and
the end-effector including an elongated wedge-shaped tip at a distal end of the end-effector that is separated from a proximal end of the end-effector along a longitudinal direction of the end-effector and a plurality of apertures in a wall of the end-effector, the plurality of apertures extending in directions that are generally transverse to the longitudinal direction.

2. The object processing system of claim 1, wherein the end-effector further includes a flexible applicator cover on the applicator, the flexible cover including cover apertures that generally align with the plurality of apertures.

3. The object processing system of claim 2, wherein the flexible applicator cover includes friction-enhancing features.

4. The object processing system of claim 3, wherein the friction-enhancing features include any of strips, discs and protrusions of elastomeric or polymeric material.

5. The object processing system of claim 1, wherein the elongated wedge-shaped tip includes a wedge angle of between about 50º from the longitudinal direction to 15º from the longitudinal direction.

6. The object processing system of claim 1, wherein the end-effector includes a bellows to which a rectangular applicator is attached, the bellows permitting flexibility in pitch and roll directions while inhibiting flexibility in compression and torsion.

7. The object processing system of claim 6, wherein the vacuum source is a high flow vacuum source providing the vacuum at the end-effector with any of an air flow of at least about 100 cubic feet per minute or a vacuum pressure of no more than about 100,000 Pascals below atmospheric.

8. A vacuum end-effector comprising a rectangular applicator that includes at least two walls that extend in a longitudinal direction toward a distal end of the applicator, the distal end of the applicator including an elongated wedge-shaped tip, and the vacuum end-effector including a plurality of apertures in a contact wall of the at least two walls of the end-effector, the plurality of apertures extending in directions that are generally transverse to the longitudinal direction.

9. The vacuum end-effector of claim 8, wherein the wall of the end-effector is provided as a wall of a rectangular applicator.

10. The vacuum end-effector of claim 9, wherein the elongated wedge-shaped tip is provided by the distal portion of the rectangular applicator.

11. The vacuum end-effector of claim 8, wherein the end-effector further includes a flexible applicator cover on the applicator, the flexible cover including cover apertures that generally align with the plurality of apertures.

12. The vacuum end-effector of claim 11, wherein the flexible applicator cover includes friction-enhancing features.

13. The vacuum end-effector of claim 12, wherein the friction-enhancing features include any of strips, discs and protrusions of elastomeric or polymeric material.

14. The vacuum end-effector of claim 8, wherein the elongated wedge-shaped tip includes a wedge angle of between about 50º from the longitudinal direction to 15º from the longitudinal direction.

15. The vacuum end-effector of claim 8, wherein the end-effector includes a bellows to which a rectangular applicator is attached, the bellows permitting flexibility in pitch and roll directions while inhibiting flexibility in compression and torsion.

16. The vacuum end-effector of claim 15, wherein the vacuum source is a high flow vacuum source providing the vacuum at the end-effector with any of an air flow of at least about 100 cubic feet per minute or a vacuum pressure of no more than about 100,000 Pascals below atmospheric.

17. A method of processing objects using an end-effector of a programmable motion device, the method comprising:
providing a plurality of objects at an input area that is proximate the programmable motion device, the end-effector of the programmable motion device being detachably and selectively attached to an end-effector and coupled to a vacuum source;
providing perception data regarding an object to be processed that is at the input area;
urging a distal portion of the end-effector between the plurality of objects in a longitudinal direction; and
grasping an object of the plurality of objects with a vacuum force in a direction that is generally transverse to the longitudinal direction.

18. The method of claim 17, wherein the method further includes sensing resistance to the end-effector moving in the longitudinal direction.

19. The method of claim 17, wherein the end-effector includes a bellows to which a rectangular applicator is attached, the bellows permitting flexibility in pitch and roll directions while inhibiting flexibility in compression and torsion.

20. The method of claim 17, wherein the selective attachment of the end-effector to the programmable motion device includes an alignment feature and a corresponding alignment recess that engages the alignment feature.
